(19) United States
(12) Patent Application Publication
(10) Pub. No.: US 2021/0197437 A1
(43) Pub. Date: Jul. 1, 2021

(54) A METHOD FOR PRODUCING A FLEXIBLE PIPE AND A FLEXIBLE PIPE

(71) Applicant: National Oilwell Varco Denmark I/S, Br¢ndby (DK)

(72) Inventor: Kristian Glejbøl, Glostrup (DK)

(21) Appl. No.: 17/057,818

(22) PCT Filed: Jun. 3, 2019
(86) PCT No.: PCT/EP2019/064341

§ 371 Date: Nov. 23, 2020

(30) Foreign Application Priority Data
Jun. 12, 2018 (DK) PA 2018 70369

(51) Int. Cl. B29C 48/00; F16L 11/08; B29C 48/09; B29C 48/21

(52) U.S. Cl. CPC B29C 48/0021; F16L 11/08; B29K 2023/12; B29C 48/21; B29C 48/09

(57) ABSTRACT

A method for producing a flexible pipe for offshore transport of fluids such as oil and gas, the method includes: extruding the internal pressure sheath of polymer material; winding one or more armor layers around the extruded internal pressure sheath; extruding the outer sheath of polymer material; at least one of the extruded sheaths of polymer material is extruded continuously along the length of the pipe wherein at least one zone A and at least one zone B are extruded along the length of the pipe and zone A is extruded from a polymer including polypropylene, and the extruded sheath in zone A has an Youngs-modulus E_{A} zone B is extruded from a thermoplastic vulcanizate polymer, and the extruded sheath in zone B has an Youngs-modulus E_{B}, where E_{B}<0.9×E_{A} and the polymers forming zone A and B are switched during extrusion to provide a continuous sheath.

### TECHNICAL FIELD

The present invention relates to a method for producing a flexible pipe for offshore transport of fluids such as oil or gas and a flexible pipe for transport of said fluids.

### BACKGROUND

Marine pipes are generally referred to as bonded pipes or unbonded pipes. A bonded pipe is generally a pipe in which the reinforcement layers are bonded to the polymer layers, which may be made from a vulcanized elastomeric material. An unbonded pipe generally comprises separate unbonded polymeric and metallic layers, which allows relative movement between layers. The present invention generally concerns unbonded flexible pipes.

Such armoured flexible pipes are suitable for marine applications such as for transport of petrochemical fluids e.g. oil or gas or in a sub-sea environment.

Armored flexible pipes for offshore applications are generally known from the standard “Recommended Practice for Flexible Pipe”, ANSI/API 17B, fifth Edition, May 2014 (hereafter API17B), and the standard “Specification for Unbonded Flexible Pipe”, ANSI/API 17J, Fourth edition, May 2014 (hereafter API17J).

Such an unbonded flexible pipe may comprise a number of independent layers, such as helically wound steel and polymeric layers, as well as extruded polymeric layers formed around a central bore. A typical steel armoured flexible pipe comprises from the inside and outwards an inner armouring layer known as the carcass, an internal pressure sheath surrounded by one or more armouring layers, such as pressure armor and tensile armor layers, and an outer sheath. Thus, the internal pressure sheath defines the bore in which the fluid to be transported is conveyed and thereby ensures internal fluid integrity and stability. In some unbonded flexible pipes the carcass may be omitted. When the carcass is omitted the pipe is referred to as being a “smooth bore” pipe. On the other hand, when the carcass is present in the bore, the pipe is referred to as a “rough bore” pipe.

In some unbonded flexible pipes only the pressure armor is made from steel whereas the tensile armor is made from fibre reinforced polymer composites. In other unbonded flexible pipes the pressure armor and the internal pressure sheath may be integrated while the tensile armor is made from steel elements.

The annular space or spaces between the internal pressure sheath and the outer sheath, which houses the steel armor layers are usually referred to as the annulus or annuli.

The armoring layers surrounding the internal pressure sheath may for example comprise one or more pressure armor layers comprising one or more armoring profiles or strips, which are wound around the internal pressure sheath at a large angle, e.g. larger than 80°, relative to the centre axis of the pipe. This or these pressure armor layers primarily compensate for radial forces in the pipe. The armoring layers surrounding the internal pressure sheath may also usually comprise one or more tensile armoring layers which are wound at a relatively small angle, such as between 10° and 50°, relative to the centre axis of the pipe. This or these tensile armor layers primarily compensate for axial forces in the pipe. The armoring layers are typically made of steel.

The flexible pipes may also comprise additional layers such as insulating layers, anti-creep layers and anti-skid layers. Such layers may e.g. be applied as extruded layers or as wound tape.

The flexible pipes may for example be applied for carrying the fluids between a hydrocarbon reservoir located under the seabed either to a junction point between subsea structures or from the seabed to a floating structure. The fluid may be a hydrocarbon fluid, such as natural gas or oil, water, CO₂ or a mixture hereof depending upon the nature of the hydrocarbon reservoir. The fluid may also be an injection fluid such as water, CO₂ or methanol.

Thus, unbonded flexible pipes are mainly used for the transport of oil and gas at large or intermediate sea depths. The mentioned construction is particularly well suited for the transport of oil and gas from subsea sources to installations at sea level where the oil and gas are being treated or forwarded for further processing such as for example by compression, filtering, separation, distillation and/or further treatment.

In general, flexible pipes are expected to have a service time of about 20 years in operation.

During operation in offshore environment the flexible pipes are exposed to heavy loads, variations in temperature and harsh chemical environment. Both during installation and in subsequent operation the pipes, furthermore, have to be flexible. Consequently, it is often necessary to produce the flexible pipes from rather expensive materials to ensure the expected service time of the flexible pipe, and, thus, the production costs are increased.

### DISCLOSURE OF THE INVENTION

An object of the present invention is to provide a flexible pipe, which can be produced with reduced cost.

A further object is to provide a flexible pipe, which can be designed with built-in properties to match conditions in the environment in which the pipe is installed for service.

In a first aspect the present invention relates to a method for producing a flexible pipe for offshore transport of fluids such as oil and gas, which pipe has a length Lₚ and a bore with a diameter D_{Bore} and comprises from the inside and out at least an internal pressure sheath of polymer material, one or more armor layers and an outer sheath of polymer material. The method comprises the steps of:

extruding the internal pressure sheath of polymer material;

winding one or more armor layers around the extruded internal pressure sheath;

extruding the outer sheath of polymer material;

optionally extruding one or more intermediate sheaths of polymer material between the internal pressure sheath and the outer sheath of polymer material;

at least one of the extruded sheaths of polymer material is extruded continuously along the length of the pipe wherein at least one zone A and at least one zone B are extruded along the length of the pipe and wherein
zone A is extruded from a polymer comprising polypropylene (PP), and where the extruded sheath in zone A has an Young-modulus E_{A}
zone B is extruded from a thermoplastic vulcanizate polymer (TPV), and the extruded sheath in zone B has an Young-modulus E_{B}, where E_{B}<0.9×E_{A}

and where the polymers forming zone A and B are switched during extrusion to provide a continuous sheath.

the length Lₚ of the pipe is the total length of pipe from end to end. A flexible pipe is normally terminated in an end-fitting and the length Lₚ is, thus, the length of the pipe between its two end-fittings. The length of the pipe is substantially coinciding with the axis of the pipe.

The term “substantially” should herein be taken to mean that ordinary product variances and tolerances are comprised.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

The terms “inside” and “outside” a layer of the pipe is used to designate the relative distance to the axis of the pipe, such that “inside a layer” means the area encircled by the layer i.e. with a shorter axial distance than the layer and “outside a layer” means the area not encircled by the layer and not contained by the layer, i.e. with a longer axial distance than the layer.

The flexible pipe also comprises a bore in which the fluids to be transported are conveyed. The bore is formed by the internal pressure sheath and has a diameter D_{Bore}, which is measured as the inner diameter of the bore, i.e. from the inner surface of the internal pressure sheath forming the bore.

According to the method the internal pressure sheath is extruded form polymer material. The internal pressure sheath, which forms the innermost polymer sheath in the pipe, is extruded either as a free standing structure or onto a carcass structure.

The other layers of the pipe are subsequently applied onto the internal pressure sheath as armor layers of wound metal strips or extruded polymer layers. One or more polymer layers may also be applied as wound tapes.

At least one of the extruded polymer layers are made with zones A and B. Zone A is mainly made from a polypropylene grade, and comprises at least 80% (w/w), such as at least 90% (w/w) polypropylene and having a Youngs modulus E_{A}.

Suitable polypropylene grades are available from several companies e.g. Exxonmobil Chemical, Emco Industrial Plastics, Inc., Chevron Phillips Chemical and LyandellBasell.

In zone B the major constituent is thermoplastic vulcanizate polymer (TPV), with a Youngs modulus E_{B} less than 90% of E_{A}. Thermoplastic vulcanizate polymer (TPV) materials is a class of polymer compounds, which are flexible, strong and show excellent chemical resistance. However, TPV is expensive compared to e.g. polypropylene (PP) which have all the important features of TPV with the exception of flexibility. TPV may e.g. be provided under the trade names Santoprene™ from Exxonmobil Chemical, Enplast Enflex® and Enplast EZPrene® from AMCO POLYMERS,

It has been found that TPV and PP are fully intermixable. Thus, no segregation will appear when the TPV and PP are mixed and extruded in the extruder.

The polypropylene grade used in one zone A is not necessarily used in another zone A, the polypropylene grades may vary to build in slightly different properties in the A zones.

In a similar manner different grades of TPV can be used for different zones B to build in slightly different properties in different B zones.

When zone A is shifted to zone B during extrusion, the resulting sheath will be continuous and there will be no sharp borderlines between the zones as the polymers used are fully intermixable. When extrusion is shifted from one compound to another, the material feed to the extruder may change either abruptly or gradually. Even if the material is changed abruptly from the feeder, the shift on the pipe will be gradual because of gradual material mixing in the barrel of the extruder. The shift between the zones A and B can be performed in no particular order. Thus, you may start extruding the sheath by extruding an A zone or a B zone.

Consequently, when extruding the polymer sheath, it is possible to start by extruding a zone A or a zone B and then switch to zone B or A, respectively. Several zones A and B may be extruded along the length of the pipe.

The thickness of the extruded polymer layer with zones A and B may be in the range 0.2 cm to 4 cm, such as in the range 0.4 to 2 cm.

As the TPV is more flexible and also more expensive than PP, it is advantageous only to use TPV where a high flexibility of the pipe is required. Thus, in an embodiment of a flexible pipe according to the invention comprising an extruded sheath with A and B zones, the end sections of the flexible pipe comprise extruded B zones, i.e. extruded from polymer comprising TPV and the middle part comprises an extruded A zone. Consequently, the flexible pipe comprises two zones B, one at each end, which zones have the high flexibility of TPV and a more rigid part (zone A) in the middle part of the pipe, which is made from a stiffer PP material.

When the polymer sheath is extruded and cooled to ambient temperature, the sheath in zone A has an Young modulus E_{A} and the sheath in zone B has an Young modulus E_{B}, where E_{B}<0.9×E_{A}. The Youngs modulus E_{A} of the sheath in the A zone may be in the range of 700 to 1200 MPa, such as in the range of 800 to 1100 MPa when measured according to ASTM E111-17. The ambient temperature is normally in the range 15 to 25° C., such as 18 to 22° C.

The Youngs modulus of the polymer sheaths determine the flexibility of the pipe. Thus, the present invention provides a flexible pipe with an extruded polymer sheath where the flexibility varies along the length of the pipe.

As mentioned the extruded sheath in zone A may in an embodiment have an Young modulus E_{A} of 1200 MPa. The Young-modulus E_{B} of zone B should be lower than 0.9×E_{A} i.e. lower than 1080 MPa to provide a zone B in the extruded sheath with high flexibility when compared with zone A.

The length of zone A and the length of zone B may be the same or different, depending of the use of the pipe.

In an embodiment the length of the zone A is in the range 100 to 3000 m such as in the range 250 to 2000 m. Thus, a pipe may be produced with a rather long zone A comprising polypropylene, which is a less expensive material than TPV.

In an embodiment the length of the zone B is in the range 5 to 500 m, such as in the range 10 to 200 m. Thus, a rather short zone B can be produced comprising TPV. The zone can be extruded in the sections of the pipe where it is desired to have a high flexibility of the pipe.

Consequently, it is possible to provide a flexible pipe with one or more extruded sheaths having zones extruded from polymer material with different Young moduli, which provide different flexibility in the extruded zones along the length of the pipe.

It is desirable to use grades of polypropylene for zone A and grades of TPV for zone B, said grades having melting points, which do not differ significantly. This will facilitate the extrusion process.

In an embodiment of the method the extruder temperature when extruding zone A is T_{A} and the extruder temperature when extruding zone B is T_{B} and where the difference between T_{A} and T_{B} is less than 25° C. Thus, the zones A and B are extruded within a narrow temperature range, which makes it easier to control the extrusion process.

In an embodiment the extruder temperature is in the range 160-260° C., such as in the range 180-230° C., when extruding the zones A and B. Thus, the extrusion process can be optimized for the different grades of polymer and the extrusion process is easier performed.

To provide a flexible pipe, which has a satisfactory capacity for transporting fluid, the method provides an embodiment where the diameter D_{Bore} of the bore is at least 5 cm (2 inches), preferably at least 7.5 cm (3 inches), such as at least 12.5 cm (5 inches).

The length of the flexible pipe L_{P} can vary within a range from about 50 m up to 3500 m, such as within a range from about 100 m to about 2500 m, such as within a range from about 200 m to about 2000 m

In the sheath or sheaths in the pipe extruded according to the invention the length of the zone(s) A is typically longer than the length of the zone(s) B, due to the fact, that the polymer material in the zone(s) B is more expensive than the polymer material used for the zone(s) A.

In an embodiment the flexible pipe is an unbonded flexible pipe, which generally is more flexible than a bonded flexible pipe.

In this context, the term “unbonded” means that at least two of the layers including the armoring layers and polymer layers are not bonded to each other. In practice, the known pipe normally comprises at least two armor layers located outside the internal pressure sheath and optionally an armor structure, a carcass, located inside the internal pressure sheath.

Although the internal pressure sheath may be extruded freestanding, the method also includes an embodiment comprising the further step of providing a carcass and extruding the internal pressure sheath onto the carcass. When using this embodiment a flexible pipe comprising a carcass can be produced in a simple manner.

In an embodiment the internal pressure sheath is extruded with at least one zone A and at least one zone B along the length of the pipe.

In an embodiment the outer sheath is extruded with at least one zone A and at least one zone B along the length of the pipe.

In an embodiment, an intermediate sheath is extruded with at least one zone A and at least one zone B along the length of the pipe.

The above mentioned embodiments make it possible to provide a flexible pipe in which the internal pressure sheath, the outer sheath or an intermediate sheath is extruded with different zones A and B which may both reduce the cost of the pipe and provide a desired flexibility in selected sections along the length of the pipe.

It is also possible to extrude the internal pressure sheath and the outer sheath with different zones A and B and optionally an intermediate sheath may likewise be extruded with different zones A and B. Thus, the zones A and B may be used and combined in various ways in the extruded polymer sheaths of the flexible pipe.

In an embodiment at least one of the armor layers wound around the pipe is a pressure armor.

The pressure armor is preferably made from metallic elongate members or strips and the elongate members or strips can be wound around the pipe preferably with a winding angle of 55 to 89 degrees, such as up to 89.8 degrees in respect of the axis of the pipe.

In an embodiment at least one of the armor layers wound around the pipe is a tensile armor.

The tensile armor is preferably made from metallic elongate members or strips and the elongate members are preferably wound around the pipe with a winding angle of 25 to 50 degrees, such as up to 55 degrees in respect of the axis of the pipe.

Normally a flexible pipe comprises more the one extruded sheath, such as the internal pressure sheath and the outer sheath and optional intermediate sheaths such as insulating layers and anti-creep layers. However, only one of the extruded layers may be extruded according to the method of the invention. In case not all the extruded layers are according to the invention, the layers which are not according to the invention may be extruded using a single grade of polypropylene or other polymers in a substantially uniform extruded layer.

Consequently, the extruded polymer layers may be extruded from polymer material selected from the group consisting of polyolefins, such as polyethylene and polypropylene; polyimide, polyamide, such as polyamide-11 (PA-11) and polyamide-12 (PA-12); polyurethanes; polyureas; polyesters; polyacetals; polyethers, such as polyether sulphone (PES); polyoxides; polysulfides, such as polyphenylene sulphide (PPS); polysulphones, such as polyarylsulphone (PAS); polyacrylates; polyethylene terephthalate (PET); polyether-ether-ketones (PEEK); polyvinyls; polyacrylonitrils; polyetherketoneketone (PEKK); copolymers of the preceding; fluorous polymers such as polyvinylidene diflouride (PVDF), homopolymers and copolymers of vinylidene fluoride (“VF2”), homopolymers and copolymers of trifluoroethylene (“VF3”), copolymers and terpolymers comprising two or more different members selected from the group consisting of VF2, VF3, chlorotrifluoroethylene, tetrafluoroethylene, hexafluoropropene, and hexafluoroethylene.

The invention also relates to a flexible pipe for offshore transport of oil and gas. The pipe has a length L_{P} and a bore with a diameter D_{Bore} and comprises from the inside and out at least an internal pressure sheath of polymer material, one or more armor layers, an outer sheath of polymer material, and optionally one or more intermediate sheaths of polymer material, wherein at least one of the sheaths of polymer material comprises at least one zone A and at least one zone B along the length of the pipe, said sheath in zone A comprises polypropylene (PP), and the extruded sheath in zone A has an Youngs modulus E_{A}, said zone B comprises a thermoplastic vulcanizate polymer (TPV), and the extruded sheath in zone B has an Youngs modulus E_{B} where E_{B}<0.9×E_{A}, and the sheath comprising zone A and zone B is continuously along the length of the pipe.

Consequently, the invention also provides a flexible pipe having at least one extruded sheath with zones having different Youngs moduli, and thus, also provides a flexible pipe with zones having different stiffness. The flexible pipe provides the possibility to adapt properties, e.g. stiffness to local conditions in the environment.

In an embodiment of the flexible pipe the zone A has an Youngs-modulus in the range 700 to 1200 MPa, such as in the range 800 to 1100 MPa. Such an Youngs-modulus provides a sufficient flexibility to the extruded sheath.

In an embodiment the flexible pipe comprises a carcass. The carcass is located in the bore of the pipe and protects the internal pressure sheath against damage if the pressure in the armour layers exceeds the pressure of the fluid transported in the pipe. The carcass is preferably manufactured from metallic elongate members and the elongate members are wound with a winding angle of about 70 to about 89 degrees in respect of the axis of the pipe to form a tubular member in the bore of the pipe.

In an embodiment at least one of the armor layers is a pressure armor.

The pressure armor can be made from metallic elongate members or strips and preferably the elongate members or strips are wound around the pipe with a winding angle of 55 to 89 degrees, such as up to 89.8 degrees in respect of the axis of the pipe.

In an embodiment of the flexible pipe at least one of the armor layers is a tensile armor.

The tensile armor is preferably made from metallic elongate members or strips and preferably the elongate members or strips are wound around the pipe with a winding angle of 25 to 50 degrees, such as up to 55 degrees in respect of the axis of the pipe.

In an embodiment the flexible pipe comprises one or more intermediate layers selected from insulating layers, anti-creep layers and anti-skid layers.

Such layers may serve to protect the flexible pipe from damage. The layers may e.g. be applied as extruded layers or as wound tapes.

The flexible pipe should be able to be reeled up on a drum to be transported to the location of installation, and in an embodiment the pipe has a minimum bending radius (MBR) of 5 m. A minimum bending radius of 5 m will allow the pipe to be reeled up on a drum, which can be transported on a ship.

### DETAILED DESCRIPTION OF THE INVENTION

The invention will now be described in further details with reference to embodiments shown in the drawing in which:

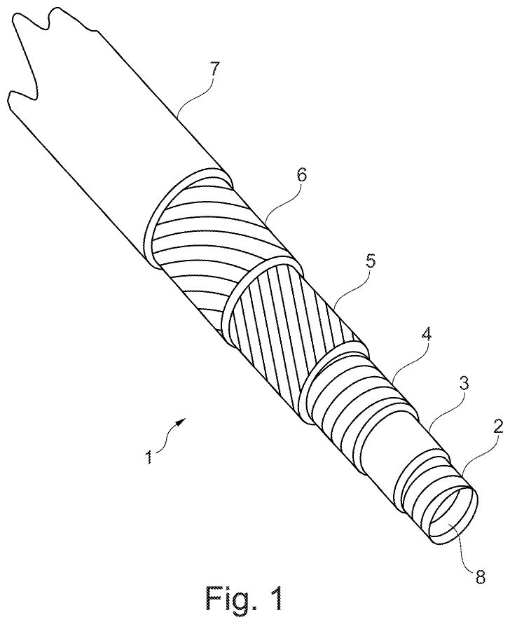

FIG. 1 shows an unbonded flexible pipe;

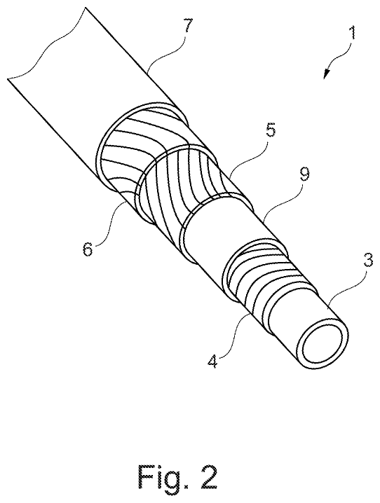

FIG. 2 shows unbonded flexible pipe with intermediate layer;

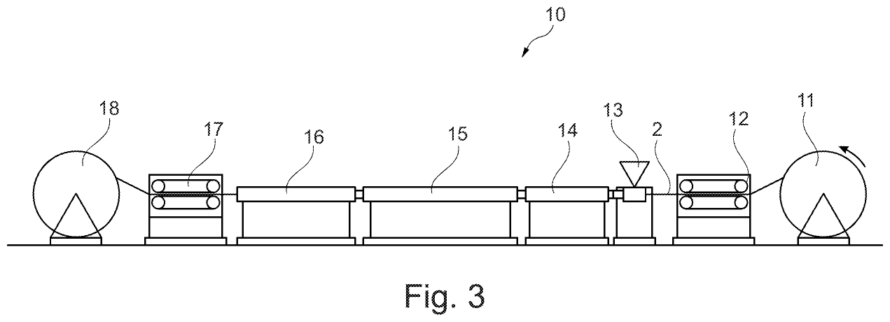

FIG. 3 shows a production line for extruding a polymer sheath;

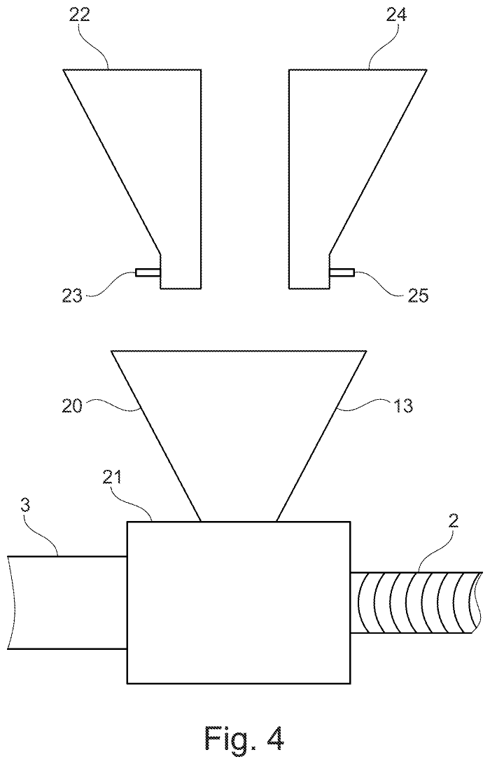

FIG. 4 shows an extruder which can be fed with two different polymers;

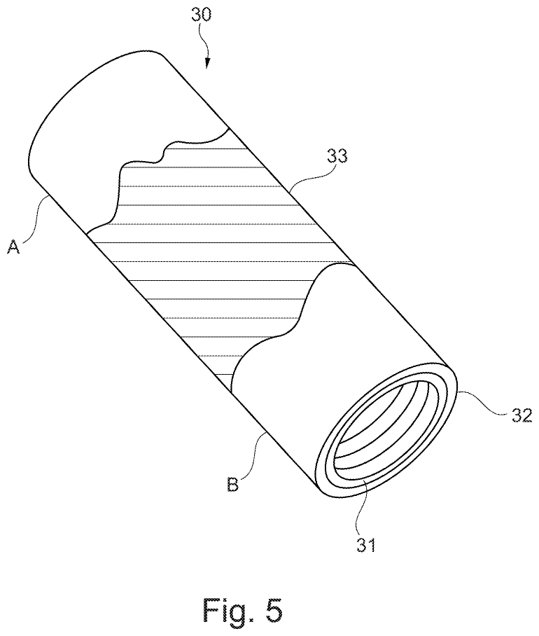

FIG. 5 shows a section of a flexible pipe according to the invention; and

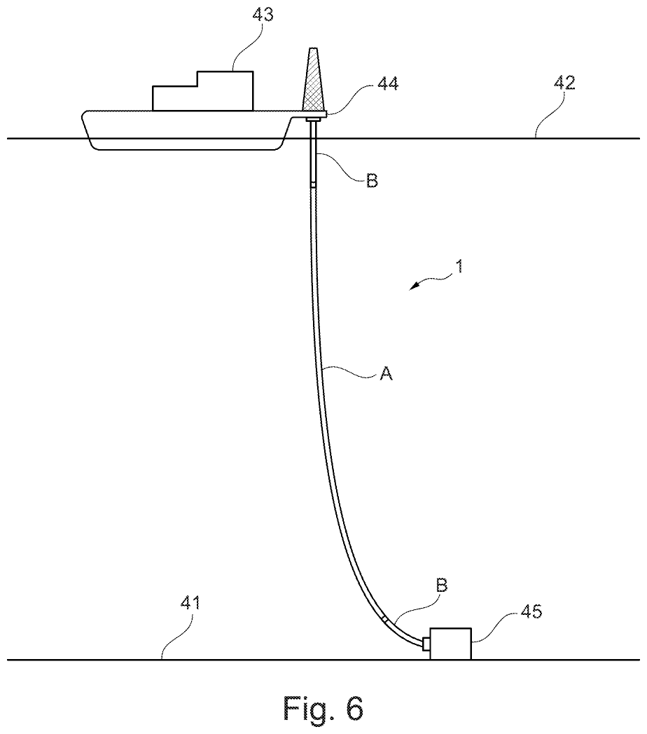

FIG. 6 shows a flexible pipe according to the invention installed between a floating facility and the seabed.

The figures are not accurate in every detail but only sketches intended to show the principles of the invention. Details which are not a part of the invention may have been omitted. In the figures the same reference numbers are used for the same parts.

FIG. 1 shows an unbonded flexible pipe 1. The pipe 1 comprises from the inside and outwards a carcass 2 to support the internal pressure sheath 3. The internal pressure sheath 3 is an extruded layer of a polymer, which is extruded onto the carcass 2.

The internal pressure sheath 3 is surrounded by a pressure armor 4 and a first tensile armor 5 and a second tensile armor 6. The outermost part of the pipe 1 is the outer sheath 7, which is also an extruded layer. Both the internal pressure sheath 3 and the outer sheath 7 are substantially fluid tight.

Between the internal pressure sheath 3 and the outer sheath 7 is formed an annulus in which the armor layers 4, 5 and 6 are located. The armor layers are made from metallic materials and, therefore, susceptible to corrosion. The armor layers are protected in the annulus between the internal pressure sheath 3 and the outer sheath 7. As the sheaths 3 and 7 forming the annulus are substantially fluid tight the sheaths are able to significantly reduce the risk that harmful and corrosive substances enter the annulus. One harmful substance is seawater which may be present on the outer side of the outer sheath 7. Other harmful substances may be corrosive gases, such as CO₂ and H₂S, which may be present in the fluid transported in the bore 8 of the pipe 1. The internal pressure sheath 6 and/or the outer sheath 7 can be provided according to the invention.

FIG. 2 shows another embodiment of an unbonded flexible pipe 1. In this embodiment the pipe 1 comprises from the inside and outwards an internal pressure sheath 3. The internal pressure sheath 3 is an extruded layer of a polymer, which has been extruded as a free standing structure as the pipe 1 does not comprise a carcass.

The internal pressure sheath 3 is surrounded by a pressure armor 4. Outside the pressure armor 4 two counter wound helical layers of tensile armor 5, 6 are applied. Between the first tensile armor 5 and the pressure armor 4 an intermediate sheath 9 is interposed. As the case of the pipe shown in FIG. 1 the outermost part of the pipe 1 is the outer sheath 7. Both the internal pressure sheath 3, the intermediate sheath 9 and the outer sheath 7 are extruded layers of polymer material and one or more of the layers can be extruded according to the invention.

The flexible pipe according to the invention can in principle be produced in well-known production facilities for producing flexible pipes. FIG. 3 shows a production line 10 for extruding a polymer sheath.

The production line 10 comprises a pay-off device or drum 11 on which a carcass 2 has been reeled up. The carcass is delivered to the extruder 13 by a caterpillar device which pulls the carcass 2 from the drum 11 and feeds it into the extruder 13.

In the extruder 13 a polymer sheath is extruded onto the carcass 2 and the carcass with the extruded sheath enters a first cooling zone 14 allowing the extruded sheath to cool. In the embodiment shown in FIG. 3 the extruded sheath is further cooled in cooling zones 15 and 16.

After the cooling the carcass with the extruded sheath passes a caterpillar device 17 before it is reeled up on a drum 18.

In this production line the carcass with the extruded sheath is reeled up on the drum 18. However, in other production lines the carcass with the extruded sheath can be conveyed directly to zones in which armor layers and additional polymer sheaths are applied.

The cooling zones 15 and 16 are in some production lines omitted and the cooling takes place in the zone 14 only.

Additional polymer sheaths may be extruded onto the flexible pipe in a similar manner.

FIG. 4 shows an extruder device 13 in which the extruded types of polymer can be shifted along the length of the pipe.

The extruder device 13 comprises a hopper 20 to which polymer material can be fed. The extruder device also comprises an extruder part 21 comprising a screw and heating devices. In this embodiment a carcass 2 is fed to the extruder part 21 at one end and leaves the extruder part 21 at the opposite end with a polymer sheath 3 extruded onto the carcass.

The extruder device also comprises two feeding devices 22 and 24 which can deliver polymer material to the hopper 20 of the extruder. The delivering of polymer material from the feeding devices 22 and 24 to the hopper 20 is controlled by metering devices 23 and 25. The metering devices 23 and 25 can be operated manually or by an automated process.

The feeding device 22 may comprise TPV material and the feeding device 24 may comprise PP. Thus, it is possible to make an easy shift between TPV and PP in the extruder 13 when extruding the sheath 3. The shift can be performed instantly or gradually. However, in the extruder the two polymers will mix up and form a zone in the extruded sheath were the polymers are intermixed.

FIG. 5 shows a section 30 of a flexible pipe according to the invention. The pipe section comprises an armor layer 31 onto which a polymer sheath 32 is extruded to cover the armor layer.

The polymer sheath 32 comprises a zone A comprising polypropylene and a zone B comprising TPV. Between the zones A and B the extruded sheath 32 comprises a zone 33 with no sharp borderlines in which the polymers are intermixed.

FIG. 6 shows a flexible pipe 1 according to the invention installed between a seabed 41 and a sea surface 42. At the sea surface 42 the flexible pipe is installed to a platform 44 on a floating facility 43.

The flexible pipe extends from the platform 44 to a subsea well 45 located at the seabed 41.

The flexible pipe 1 comprises two zones B at each end and one zone A between the two zones B. The outer sheath of the flexible pipe 1 is manufactured according to the invention and in zone A the outer sheath is made from extruded polypropylene and in the zones B the outer sheath is made from extruded thermoplastic vulcanizate polymer. Thus, the outer sheath in the end zones B provides more flexibility to the pipe than the longer mid zone A.

### Example

A flexible pipe is extruded according to the invention. The extruded pipe has a length of approx. 100 m and the outer sheath is extruded according to the invention.

Flexible pipe comprises a carcass on which an internal pressure sheath of polyethylene with thickness of approx. 8 mm is extruded.

On the outer side of the internal pressure sheath a first metal strip is wound with an angle of approx. 87° to form a pressure armor. Two layers of a second metal strip are cross-wound around the pressure armor with an angle of approx. 45° to form tensile armors.

The flexible pipe is now ready for the extrusion of the outer sheath onto the tensile armor.

The TPV is Santoprene 203-50 from Exxon Mobile.

The PP is ASI Polypropylene 3486-01 Homopolymer from A. Schulman Inc.

The two polymer grades are delivered as pellets and the TPV grade is dried 2 hours at approx. 80° C. before the extrusion.

The extrusion of the outer sheath with thickness approx. 8 mm is performed on a conventional single screw extruder with a 120 mm screw diameter and an L/D ratio of 25-30.

The temperature setting on the heating zone of the extruder ranges from about 160 to about 185° C. and with a head temperature of approx. 185° C. the typical melt temperature outside of the extruder will be approx. 190° C.

After extrusion of a first zone based on TPV and with a length of approx. 20 m the polymer in the hopper is shifted to PP, which is transported into the extruder and extrusion continued to extrude a second zone having a length of approx. 80 m without or with only very small adjustments of the parameters.

After extrusion through the head the outer sheath is cooled in air and subsequently in a cooling bath with temperature gradient to secure efficient slow cooling to avoid phase changes and tension the polymer structure.

After the cooling outer sheath extruded by TPV (first zone) has a Youngs modulus of approx. 500 MPa and the outer sheath extruded by PP has a Youngs modulus of approx. 1000 MPa.

What is claimed is:

1-20. (canceled)

21. A method for producing a flexible pipe for offshore transport of fluids, wherein said pipe having a length Lₚ and a bore with a diameter D_{Bore} and comprises at least one continuous extruded sheath of polymer material, wherein the method comprises extruding said at least one continuous extruded sheath of polymer material is extruded continuously along the length of the pipe, wherein at least one zone A and at least one zone B are extruded along the length of the pipe and wherein:
zone A is extruded from a polymer comprising polypropylene (PP), and where the extruded sheath in zone A has a Youngs modulus E_{A};
zone B is extruded from a thermoplastic vulcanizate polymer (TPV), and the extruded sheath in zone B has a Youngs modulus E_{B}, where E_{B}<0.9×E_{A};
and wherein the polymers forming zone A and B are switched during extrusion.

22. The method according to claim 21, wherein the flexible pipe comprises from the inside and out an internal pressure sheath of polymer material, one or more armor layers and an outer sheath of polymer material, said method comprises:
extruding the internal pressure sheath of polymer material;
winding one or more armor layers around the extruded internal pressure sheath;
extruding the outer sheath of polymer material; and
extruding one or more intermediate sheaths of polymer between the internal pressure sheath and the outer sheath of polymer material;
wherein the extrusion of at least one of the extruded sheaths of polymer material is provided by the extrusion of said least one continuous extruded sheath of polymer material.

23. The method according to claim 21, wherein the extruded sheath in zone A has a Youngs modulus in the range 700 to 1200 MPa.

24. The method according to claim 21, wherein the length of the zone A is in the range 100 to 3000 m.

25. The method according to claim 21, wherein the length of the zone B is in the range 5 to 500 m.

26. The method according to claim 21, wherein the extruder temperature when extruding zone A is T_{A} and the extruder temperature when extruding zone B is T_{B} and wherein the difference between T_{A} and T_{B} is less than 25° C.

27. The method according to claim 21, wherein the extruder temperature is in the range 160-260° C.

28. The method according to claim 21, wherein the diameter D_{Bore} of the bore is at least 5 cm (2 inches).

29. The method according to claim 22, comprising the further step of providing a carcass and wherein said internal pressure sheath being extruded onto the carcass.

30. The method according to claim 21, wherein said at least one continuous extruded sheath of polymer material extruded with at least one zone A and at least one zone B along the length of the pipe is selected from an internal pressure sheath, an outer sheath or an intermediate sheath.

31. The method according to claim 22, wherein one or more armor layers comprises a pressure armor.

32. The method according to claim 22, wherein said one or more armor layers comprises a tensile armor.

33. A flexible pipe for offshore transport of fluids, said pipe having a length L_{P} and a bore with a diameter D_{B}, wherein said flexible pipe comprises at least one continuous extruded sheath of polymer material, said at least one continuous extruded sheath of polymer material comprising at least one zone A and at least one zone B along the length of the pipe, said sheath in zone A comprises polypropylene (PP) and having a Youngs modulus E_{A}, said sheath in zone B comprises a thermoplastic vulcanizate polymer (TPV) and having a Youngs modulus E_{B}, wherein E_{B}<0.9×E_{A}, and wherein said sheath comprising zone A and zone B is continuous along the length of the pipe.

34. The flexible pipe of claim 33, wherein said pipe comprises from the inside and out at least an internal pressure sheath of polymer material, one or more armor layers, an outer sheath of polymer material, and one or more intermediate sheaths of polymer material, wherein at least one of the sheaths of polymer material is provided by said at least one continuous extruded sheath of polymer material.

35. The flexible pipe according to claim 33, wherein zone A has a Youngs modulus in the range 700 to 1200 MPa.

36. The flexible pipe according to claim 33, wherein the pipe comprises a carcass.

37. The flexible pipe according to claim 34, wherein one or more armor layers comprises a pressure armor.

38. The flexible pipe according to claim 34, wherein one or more armor layers comprises a tensile armor.

39. The flexible pipe according to claim 33, wherein the flexible pipe comprises one or more intermediate layers selected from insulating layers, anti-creep layers and anti-skid layers.

40. The flexible pipe according to claim 34, wherein the pipe has a minimum bending radius (MBR) of 5 m.
